(19) United States
(12) Patent Application Publication
(10) Pub. No.: US 2020/0210553 A1
(43) Pub. Date: Jul. 2, 2020

(54) PROTECTION OF DATA AND DEEP LEARNING MODELS FROM PIRACY AND UNAUTHORIZED USES

(71) Applicant: 12 Sigma Technologies, San Diego, CA (US)

(72) Inventors: Dexu Lin, San Diego, CA (US); Langechuan Liu, Encinitas, CA (US); Dashan Gao, San Diego, CA (US); Xin Zhong, San Diego, CA (US)

(73) Assignee: 12 Sigma Technologies, San Diego, CA (US)

(21) Appl. No.: 16/235,603

(22) Filed: Dec. 28, 2018

(51) Int. Cl. G06F 21/12; G06N 3/08; G06N 3/04; G06F 21/62; G06F 21/10

(52) U.S. Cl. CPC G06F 21/12; G06N 3/08; G06F 2221/0713; G06F 21/6218; G06F 21/105; G06N 3/04

(57) ABSTRACT

This disclosure is directed to methods and systems for protecting a deep learning model from piracy and unauthorized uses. The protection may be implemented by embedding an ownership detection mechanism such that unauthorized use of the model may be detected using a detection input data and corresponding model signature. In addition, the deep learning model may be used in conjunction with a secret or license protected data encoder such that the deep learning model may generate meaningful output only when processing encoded input data. An unauthorized user who does not have access to the secret data encoder may not be able to use a pirated copy of the deep learning model to generate meaningful output. Under such a scheme, a deep learning model itself may be widely distributed without restriction and without license-protection.

### TECHNICAL FIELD OF THE INVENTION

This disclosure relates to systems and methods for protecting distribution of deep-learning artificial intelligence (AI) models from piracy and unauthorized uses.

### BACKGROUND OF THE INVENTION

Artificial intelligence (AI) models may be trained to perform intelligent tasks such as classification and pattern recognition in a variety of types of input data. An AI model may be based on deep learning techniques and include, for example, one or more complex networks of cascading layers of interconnecting neurons. Such an AI model may be subject to piracy and unauthorized uses during and after deployment and distribution. Embedded and inherent ability to detect ownership and/or prevent such authorized uses may help reduce piracy and protect assets and market shares of owners of AI models.

### SUMMARY OF THE INVENTION

This disclosure is directed to systems and methods for protecting data and deep-learning AI models from piracy and unauthorized uses. In one aspect, ownership of an unauthorized copy of an AI model may be detected using special input detection data. In particular, the AI model may be trained such that its inner workings may be imprinted on the special input detection data to generate a predefined model signature of ownership as output. In another aspect, unauthorized uses of the AI model may be prevented by requiring a separate license protected or secrete data encoder to generate encoded data from input data and use the encoded data as input data to the AI model. The AI model, for example, may be trained such that it would not generate meaningful output when the input data is not properly encoded by the license protected or secrete encoder.

In one implementation, an artificial intelligence system is disclosed. The system may include a repository for storing a predictive deep learning model and a processing circuitry in communication with the repository. The processing circuitry may be configured to receive a predetermined input detection data and normal input data, forward propagate the normal input data through the predictive deep learning model to generate a predictive output, forward propagate the predetermined input detection data through the predictive deep learning model to generate a detection output, obtain a difference between the detection output and a predetermined model signature corresponding to the predetermined input detection data, determine that the predictive deep learning model is an unauthorized copy when the difference between the detection output and the predetermined model signature is smaller than a predetermined threshold; and determine that the predictive deep learning model is not an unauthorized copy when the difference between the detection output and the predetermined model signature is not smaller than a predetermined threshold.

In the implementation above, the predictive deep learning model may include a single multilayer deep learning network and the single multilayer deep learning network is trained integrally using a training data set comprising input data labeled with corresponding ground truth and a predetermined set of detection data labeled with corresponding predetermined model signatures.

In any of the implementations above, the predictive deep learning model may include a main deep learning network and a detection network separately trained from the main deep learning network. The predetermined input detection data may be forward propagated through the detection network and the normal input data may be forward propagated through the main deep learning network.

In any of the implementations above, the main deep learning network may be trained using a normal set of input training data with corresponding ground truth labels and the detection network is separately trained using a predetermined set of detection data labeled by a set of model signatures corresponding to the set of predetermined detection data.

In any of the implementations above, the processing circuitry may be further configured to recognize whether an input data is a normal input data or a predetermined input detection data

In any of the implementations above, the detection network and the main deep learning network include independent model parameters. In any of the implementations above, the predictive deep learning model may include a multilayer convolutional neural network.

In another implementation, an artificial intelligence method is disclosed. The method may include obtaining a set of input training data each associated with one of a set of corresponding ground truth labels; encoding each of the set of input training data using a license protected data encoder to obtain a set of encoded input training data. The method may further include training a predictive deep learning network to generate a trained predictive deep learning network by iteratively front propagating each of the set of encoded input training data through the predictive deep learning network to obtain prediction output; and back propagating loss function derived from the prediction output and ground truth labels corresponding to the set of input training data based on gradient descent, wherein a forward propagation output of an encoded input training data through the trained predictive deep learning network differs from a forward propagation output of an input training data through the trained predictive deep learning network by more than a predetermined difference threshold. The method may further include receiving an unlabeled input data; encoding the unlabeled input data using the license protected data encoder to obtain an encoded unlabeled input data; and forward propagating the encoded unlabeled input data through the trained predictive deep learning network to generate a predictive output label.

In the implementation above, the predictive deep learning network may be unprotected. In any of the implementations above, the predictive deep learning network may be distribute via a cloud computing platform. In any of the implementations above, the license protected data encoder may include a one-way function for converting an input data to an encoded input data. In any of the implementations above, the license protected data encoder may include a fixed random two-dimensional convolution that converts an input data to an encoded input data.

In any of the implementations above, the license protected data encoder may be configured to superpose a predetermined data pattern onto an input data to generate an encoded input data. In any of the implementations above, the predictive deep learning network may include a data decoder corresponding to the license protected data encoder in addition to and before a multilayer deep-learning network. In any of the implementations above, the predictive deep learning network may include a multilayer convolutional neural network. In any of the implementations above, the set of input training data may include a normal input training data associated with a corresponding set of ground truth and a predetermined set of detection training data associated with a corresponding predetermined set of model signatures.

In any of the implementations above, the predictive deep learning network may include a single multilayer deep learning network and the single multilayer deep learning network may be trained integrally using the normal input training data associated with the corresponding set of ground truth and the predetermined set of detection training data associated with the corresponding predetermined set of model signatures.

In any of the implementations above, the method may further include forward propagating one of the predetermined set of detection training data through the trained predictive deep learning network to generate an detection output; obtaining a difference between the detection output and a predetermined model signature corresponding to the one of the predetermined set of detection training data; determining that the predictive deep learning network is an unauthorized copy when the difference between the detection output and the predetermined model signature is smaller than a predetermined threshold; and determine that the predictive deep learning network is not an unauthorized copy when the difference between the detection output and the predetermined model signature is not smaller than a predetermined threshold

In any of the implementations above, the predictive deep learning network may include a main deep learning network and a detection network separately trained from the main deep learning network. The predetermined set of detection training data and the corresponding predetermined set of model signatures is used for training the detection network. The normal input training data and the corresponding set of ground truth may be used for training the main deep learning network.

In any of the implementations above, the method may further include forward propagating one of the predetermined set of detection training data through the trained detection network to generate a detection output; obtaining a difference between the detection output and a predetermined model signature corresponding to the one of the predetermined set of detection training data; determining that the predictive deep learning network is an unauthorized copy when the difference between the detection output and the predetermined model signature is smaller than a predetermined threshold; and determine that the predictive deep learning network is not an unauthorized copy when the difference between the detection output and the predetermined model signature is not smaller than a predetermined threshold.

### BRIEF DESCRIPTION OF THE SEVERAL VIEWS OF THE DRAWINGS

FIG. 1 illustrates an exemplary deep learning model capable of self-detection of model ownership and unauthorized uses.

FIG. 2 illustrates an exemplary training process of the deep learning model of FIG. 1.

FIG. 3 illustrates another exemplary deep learning model capable of self-detection of model ownership and unauthorized uses.

FIG. 4 illustrates an exemplary training process of the deep learning model of FIG. 3.

FIG. 5 illustrates an exemplary deep learning model capable of preventing unauthorized uses.

FIG. 6 illustrates an exemplary training process of the deep learning model of FIG. 5.

FIG. 7 illustrates another exemplary deep learning model capable of preventing unauthorized uses.

FIG. 8 illustrates an exemplary training process of the deep learning model of FIG. 7.

FIG. 9 illustrates an exemplary implementation of the data encoder of FIG. 5-8.

FIG. 10 illustrates an alternative implementation of the data encoder of FIG. 5-8.

FIG. 11 illustrates an exemplary distributed computing system for implementing the deep learning models of FIGS. 1, 3, 5, and 7.

FIG. 12 illustrates exemplary deployment of the deep learning models of FIGS. 1, 3, 5, and 7 in a cloud computing environment.

FIG. 13 illustrates computing components for implementing various systems and devices of FIGS. 11 and 12.

### DETAILED DESCRIPTION OF THE INVENTION

Artificial intelligence techniques have been widely used for processing large amount of input data to recognize correlations within and among input data items and extract categorical and other features. These techniques may be implemented in a wide range of applications to perform various intelligent tasks. Deep learning techniques based on, e.g., multilayer convolutional neural networks (CNNs), may generate CNN models trained for processing particular types of input data to extract particular types of information embedded the input data, including but not limited to categorical/classification information, clustering information, pattern information, and the like. The term CNN model is herein used interchangeably with other terms such as “deep learning model”, “deep learning CNN model”, “multilayer CNN model”, and the like.

A deep learning CNN model may include multiple cascading convolutional, pooling, rectifying, and fully connected layers of neurons, with millions of kernel, weight, and bias parameters. These parameters may be determined by training the model using a sufficient collection input data that are pre-associated with a corresponding set of ground truth labels, such as categories, boundary boxes, segmentation masks, and any other types of labels that are of particular interest. Once a CNN model is trained and the model parameters are optimized, it may be used for processing unlabeled input data and predicting labels for the unlabeled input data.

In an exemplary training process of a CNN model, each of a large number of labeled training datasets may be forward propagated through the layers of neurons of the CNN network with predetermined inter-connectivity and embedded with the training parameters to calculate an end labeling loss. Back propagation is then performed in an opposite direction through the layers of the interconnecting neurons while adjusting the training parameters to reduce labeling loss based on gradient descent. The forward/back propagation training process for all training input datasets iterates until the neural network produces a set of training parameters that provide converging minimal overall loss for the labels predicted by the neural network over the ground truth labels pre-associated with the training datasets. A converged model then includes a final set of training parameters and neural connectivity, and may then be tested and used to process unlabeled input datasets via forward propagation. Such a CNN model typically must be of sufficient size in terms of number of layers and number of neurons/features in each layer for achieving acceptable predictive accuracy. The number of training parameters is directly correlated with the size of the neural network, and is typically extraordinarily large even for a simple AI model (on the order of millions, tens of millions, hundreds of millions, and thousands of millions of parameters).

In one implementation, the input data may include digital images. A trained deep-learning model may be capable of classifying an input image into one of a predefined set of categories, segmenting an input image into regions, and/or recognizing predefined types of objects in the input image and generating boundary boxes for the recognized objects. For example, a digital image may contain one or more regions of interest (ROIs). An ROI may be a particular type of object. In many applications, only image data within the ROIs contains useful information. As such, recognition of ROIs in a digital image and identification of boundaries for these ROIs using computer vision often constitute a critical first step before further image processing is performed. A digital image may contain multiple ROIs of a same type or may contain ROIs of different types. For example, a digital image may contain only human faces or may contain both human faces of and other objects of interest.

ROIs, once determined, may be represented by digital masks. ROI masks are particularly useful for further processing of the digital image. For example, an ROI mask can be used as a filter to determine a subset of image data that are among particular types of ROIs and that need to be further analyzed and processed. Image data outside of these particular types of ROIs may be removed from further analysis. Reducing the amount of data that need to be further processed may be advantageous in situations where processing speed is essential and memory space is limited.

The identification of ROIs in digital images using integrated or separate deep learning models may be deployed in various intelligent image analytics applications, including but not limited to face identification and recognition, object identification and recognition, satellite map processing, and general computer vision. In particular, these models may be implemented in medical image processing and analytics. Such medical images may include but are not limited to Computed Tomography (CT) images, Magnetic Resonance Imaging (MRI) images, ultrasound images, X-Ray images, and the like. In Computer-Aided Diagnosis (CAD) applications, for example, a single or a group of images may first be analyzed and segmented into ROIs and non-ROIs. One or more ROI masks may be generated. An ROI in a medical image may be specified at various levels depending on the applications. For example, an ROI may be an entire organ. As such, a corresponding ROI mask may be used to mark the location of the organ tissues and mark the regions outside of the ROI that are not part of the organ. For another example, an ROI may represent a lesion in an organ or tissue of one or more particular types in the organ. These different levels of ROIs may be hierarchical. For example, a lesion may be part of and within an organ. Identification of different levels of ROIs may be performed by an integrated deep learning model or may be performed by separate deep learning models. Further, characteristics of these various levels of ROIs (such as their classifications) may be further determined using the same or separate one or more deep learning models. Such characteristics may form the basis for Computer-Aided Diagnosis. For example, a region of tissue may be identified and diagnosed as benign or malignant.

Examples for using deep learning models to processing digital medical images for CAD applications have been disclosed in patent applications belonging to the same Applicant as this current application, including but not limited to U.S. patent application Ser. No. 15/943,392, filed with U.S. Patent Office on Apr. 2, 2018, U.S. patent application Ser. No. 16/104,449, filed with U.S. Patent Office on Aug. 17, 2018, PCT International Patent Application No. PCT/US2018/57529, filed with the U.S. Patent Office on Oct. 25, 2018, and PCT International Application No. PCT/US2017/035052, filed with the U.S. Patent Office on May 30, 2017, the entirety of which are herein incorporated by reference.

The deep learning models above are usually architecturally complex and difficult to design and train. The pre-labeling of training dataset often takes laborious efforts. In addition, the models do not always converge easily. As such, a relatively accurate model usually takes a large team and significant efforts to develop. A trained model thus constitutes precious asset of its owner/developer. It is thus desirable to protect a trained model from piracy and unauthorized uses, just like any other types of software products.

In some implementations, a trained model may be incorporated by the model owner in standalone applications distributed using license control management technologies. In some other implementations, binary version of a trained model may be widely distributed for incorporation by other application developers. In the latter situation, direct license control for the model may be cumbersome and impractical. As such, mechanisms for protecting the trained model from piracy and unauthorized uses without having to attach a license to the model or control/restrict the distribution of the model may be beneficial to facilitating a widespread and speedy distribution of the model.

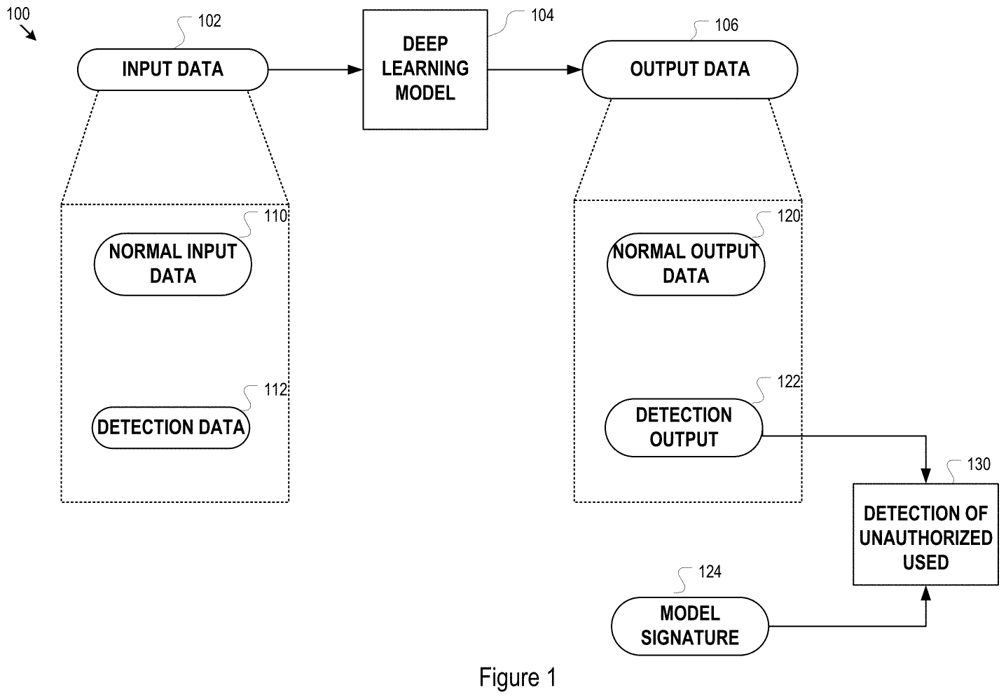

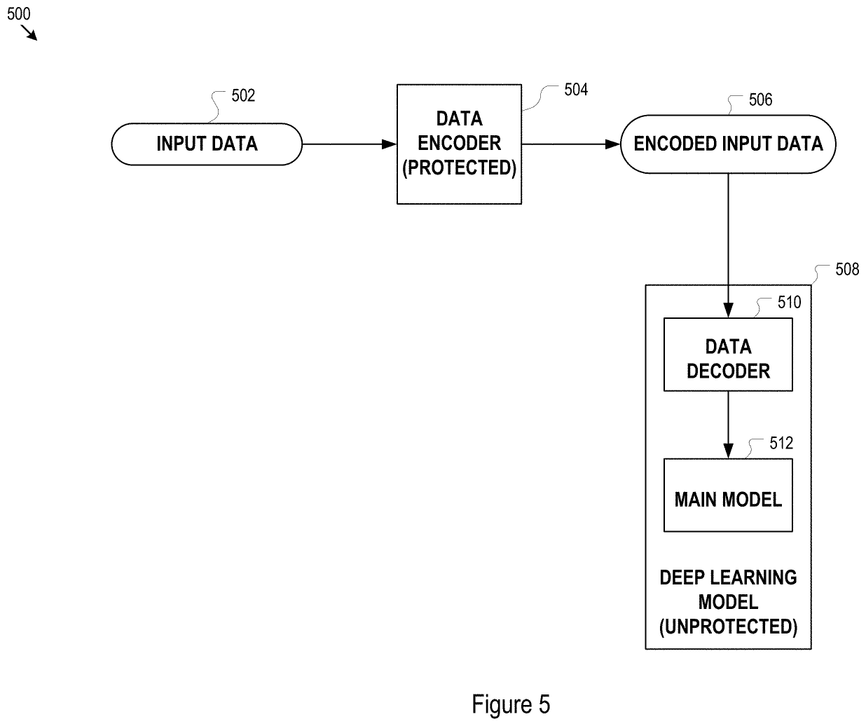

In some embodiments, protection of a trained deep learning model from piracy and unauthorized use may be implemented in, e.g., two general aspects. In the first aspect, the protection may be implemented by discouraging piracy by providing an embedded and inherent ability of model ownership detection. For example, an embedded detection mechanism may be put in place such that ownership of the model may be detected or confirmed and as such, a pirated copy of the model or copy obtained in an unauthorized manner may be detected with sufficient certainty. Existence of such an embedded detection mechanism may be effective in deterring temptation to pirate. Implementations illustrated in FIGS. 1-4 below are directed towards the first aspect of protection. In the second aspect, preemptive or preventive protection may be implemented. For example, the trained model may be constructed such that unauthorized use of a pirated copy of the model may not produce any usable output. The implementations illustrated in FIGS. 5-10 are directed towards this second aspect of protection. As will be shown in more detail below, the first and second aspects of protection above may be further combined into a more robust scheme for ownership detection as well as preemptive protection of the trained model from piracy and unauthorized uses.

FIG. 1 illustrate an exemplary implementation 100 of a deep learning model capable of self-detection of ownership, piracy and unauthorized uses. The deep learning model 104 may be a contiguous neural network trained end-to-end with embedded capability of detecting ownership of the model and determining whether the model 104 is an unauthorized copy, by using special input detection data 112 associated with model signature 124.

In particular, the deep learning model 104 may be trained to process input data 102 and generate output data 106. The input data 102 may include normal input data 110 and predetermined special detection data 112. Correspondingly and respectively, the deep learning model 104 may generate normal output data 120 and detection output 122. The special detection data 112 may be pre-associated with model signature 124. In a detection process, the detection data 112 may be input by a tester (e.g., the true owner) into a suspected model (also referred to as 104) to generate detection output 122. The detection output 122 may be compared with the predetermined model signature 124 in process 130 for detection of ownership and unauthorized use. Specifically, difference between the detection output 122 and the model signature 124 may be obtained and analyzed. In one implementation, if the difference is smaller than a predetermined difference threshold, process 130 may confirm that the ownership of the suspected model does belong to the tester and determine that the deep learning model 104 is an unauthorized copy. If the difference is not smaller than the predetermined difference threshold, process 130 may determine that the suspected deep learning model 104 is not an unauthorized copy with respect to the ownership being detected. The predetermined difference threshold may be adjusted according to a desired detection sensitivity. Alternatively, the difference may be analyzed to generate a probability with which the deep learning model 104 belongs to the tester and is an unauthorized copy.

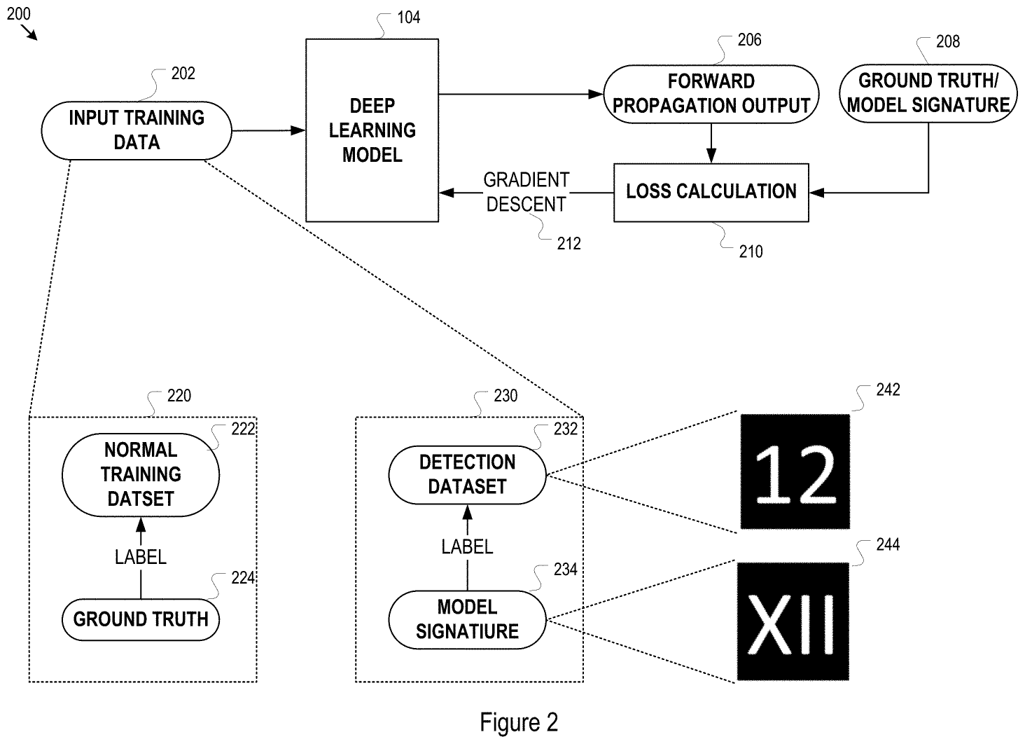

FIG. 2 illustrates an exemplary training process 200 of the deep learning model 104 of FIG. 1. The deep learning model 104 may be trained as a single contiguous neural network in an end-to-end manner. The training datasets may include subset 220 and subset 230. The subset 220 may include normal training dataset 222 labeled with ground truth 224. The subset 230 may include special detection dataset 232 labeled with model signature 234. There may be multiple different special detection data within the dataset 232 each labeled with corresponding model signature. In the situation where input data to the deep learning model 104 are digital images, 242 and 244 of FIG. 2 respectively illustrate an exemplary detection data and corresponding model signature.

During the training process, the training data 202 including both the normal training dataset 220 and detection dataset 230 may be forward propagated through the various layers of the deep learning model 104 to generate forward propagation output 206. End Loss is then calculated. As shown by 208 and 210, the loss may be calculated based on difference between the forward propagation output 206 and labels 208. Depending on whether the particular input training data are normal training data or detection data, the labels 208 may be either ground truth label 224 or model signature 234. The loss may then be back propagated through the various layers of the deep learning model 104. The model parameters, including various kernel, weight, bias and other parameters may be adjusted to minimize the loss based on gradient descent techniques, as shown by 212. The training process above iterates for each input data and for the entire input dataset, until the model parameters converge to produce a model that correctly predicts labels for the input data at an acceptable accuracy level.

In some implementations, the training process may be biased towards either the normal training dataset 222 or the detection dataset 232. For example, the training process may be biased towards the detection dataset 232 if detection of piracy and unauthorized use of the deep learning model 104 is of utmost importance to the model owner. In a particular implementation, loss functions for calculating the end loss 210 may be constructed such that the loss for the detection dataset 232 is amplified with respect to the loss for the normal training dataset 222.

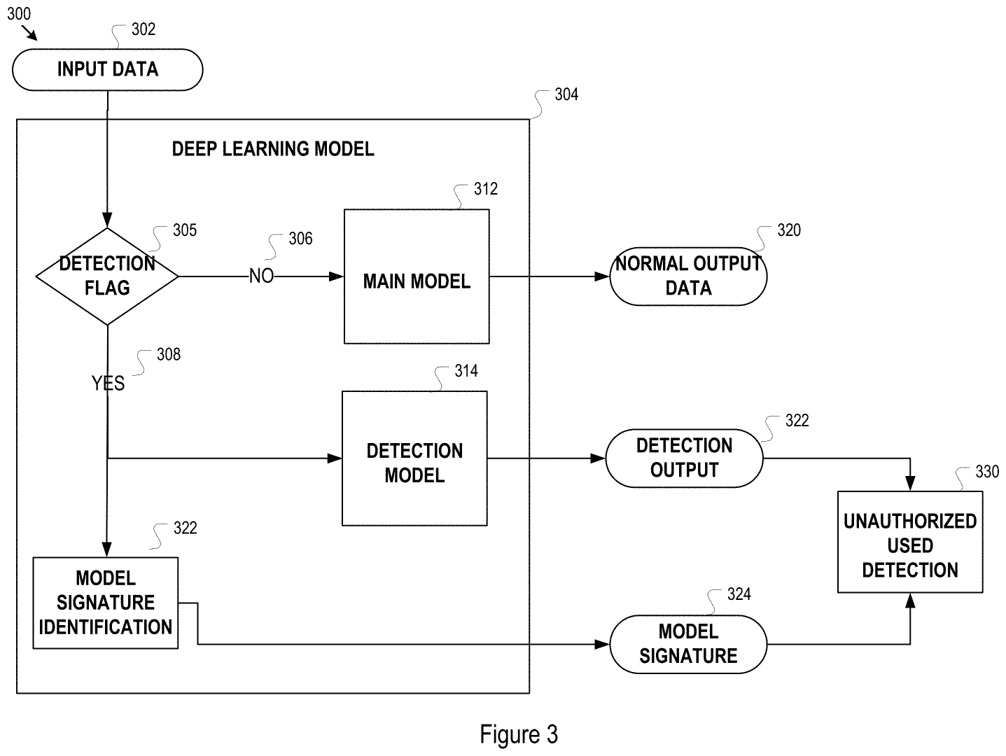

FIG. 3 shows another exemplary implementation 300 of deep learning model capable of self-detection of model ownership, piracy, and unauthorized uses. In comparison to the implementation 100 of FIG. 1, the deep learning model 304 in the implementation 300 of FIG. 3 includes separate models 312 and 314. The model 312 may include a main model used for processing normal input data while model 314 may include a detection model used for processing detection data when detection of the ownership of the model 304 is called for. The main model 312 and the detection model 314 may be independently trained to handle respective input data.

As shown in FIG. 3, the input data 302 may be provided to the deep learning model 304. In a normal operation of the deep learning model 304, the input data 302 may include normal input data that need to be predicatively labeled by the deep learning model 304. When the deep learning model 304 is used in a detection mode, the input data 302 may include predetermined detection data rather than normal input data. As such, the deep learning model 304 may include a process 305 for determining the operation mode of the model. For example, the deep learning model 304 may perform a preliminary processing and analysis of the input data 302 to look for characteristics that identify the input data as one of the predetermined detection data. Once it is determined that the input data 302 is not among the predetermined set of detection data, the input data 302 may then be identified as normal input data and directed to the main model 312 rather than the detection model 312 to generate normal output data 320. On the other hand, if it is determined that the input data 302 is among the predetermined set of detection data, the input data 302 may then be directed to the detection model 314 rather than the main model 312 to generate detection output 322.

The detection output 322 may be further compared with the model signature 324 corresponding to the input detection data and as identified by the model signature identification process 322 within the deep learning model 304. Specifically, difference between the detection output 322 and the model signature 324 may be obtained and analyzed. In one implementation, if the difference is smaller than a predetermined difference threshold, process 330 may confirm the ownership of the deep learning model 304 and further determine that deep learning model 304 is an unauthorized copy. If the difference is not smaller than the predetermined difference threshold, process 330 may determine that deep learning model 304 is not an unauthorized copy. The predetermined difference threshold may be adjusted according to a desired detection sensitivity. Alternatively, the difference may be analyzed to generate a probability that the deep learning model 304 is owned by the tester and is an unauthorized copy.

In the implementation of FIG. 3, the main model 312 for processing normal input data and the detection model 314 for processing detection data may each include, for example, a multi-layer convolutional neural network, and may be separately and independently trained. Users of the deep learning model 304 may not need to be aware of the existence of the detection model or network 314 even though it may always be embedded in the overall deep learning model 304. The determination of detection data and the invoking of the detection model 314 may be encapsulated inside the deep learning model 304, as shown in FIG. 3 and described above.

One of the advantages of using independent main model 312 and detection model 314 is that the potential disparity between the general characteristics of the normal input data and the detection data may not become a factor that affects predictive accuracy of the deep learning model 304. If a single model rather than separate models is trained, the training process may have to force a competition between predictive accuracy of normal input data and detection data. Separating processing of the normal input data and detection data allows better and stronger design of detection data and model signature without being handicapped by disparity between such detection data and the normal input data in general data characteristics.

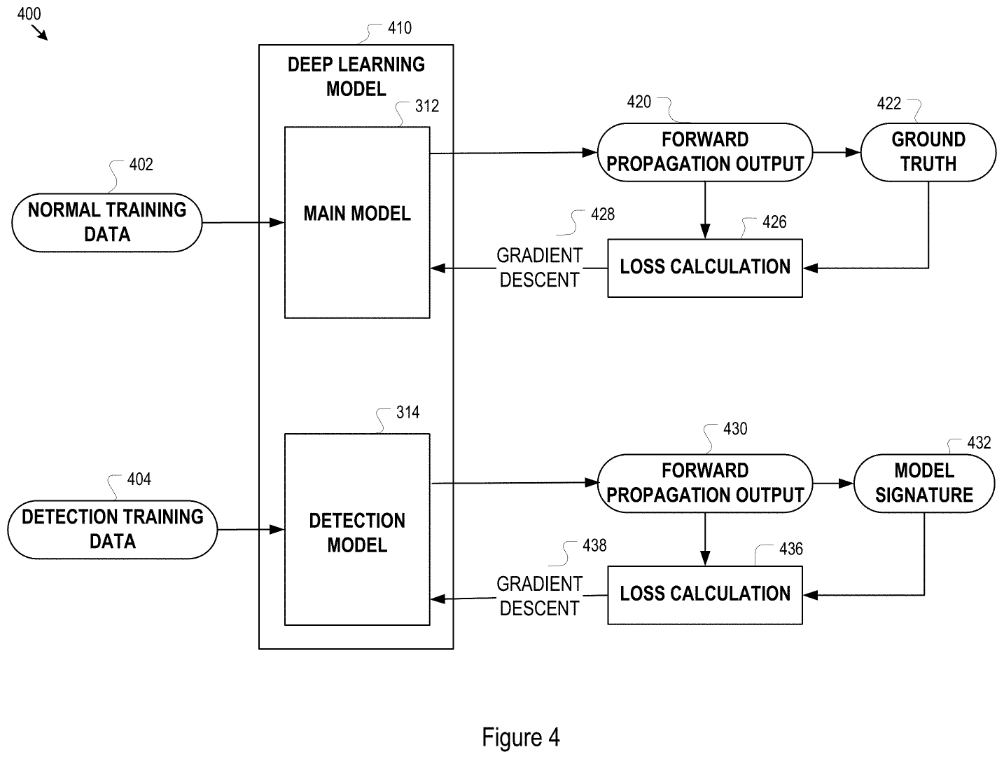

FIG. 4 illustrates an exemplary training process 400 of the deep learning model of FIG. 3. The training process illustrated in FIG. 4 is similar to FIG. 2, except that the main model 312 and the detection model 314 are separately trained using separate normal training data 402 and detection training data 404. The generation of forward propagation output 420/430, the loss calculation 426/436 based on the forward propagation output 420/430 and ground truth or model signature 422/432, and back propagation with gradient decent 428/438 are similar to corresponding data or processes described in FIG. 2 and are not duplicated here for FIG. 4.

The implementations above in FIGS. 1-4 are thus directed to protection of the trained deep learning model by detecting ownership of the model. Implementations illustrated in FIGS. 5-10 below, on the other hand, are directed to preemptive and preventive protection of the trained deep learning model from piracy and unauthorized use. FIG. 5 shows one such example. Specifically, rather than processing the input data 502 directly, the deep learning model 508 is trained to process an encoded version of the input data 506 by a data encoder 504. Within the deep learning model 508, a corresponding data decoder 510 may be included before a main model 512. As such, the deep learning model 512 may first decode the encoded input data provided to the model and then feed the output of the data decoder 510 to the main model 512 for processing and for generation of output labels.

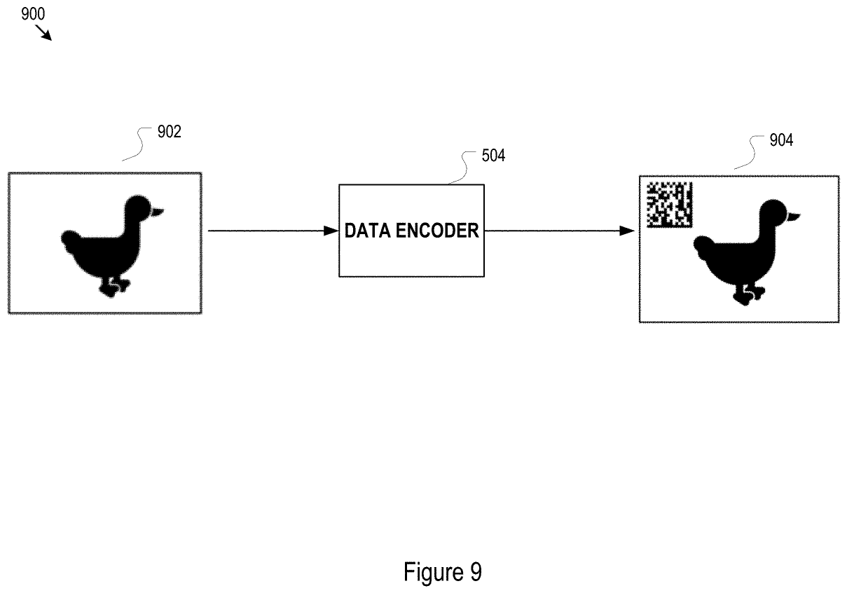

In another implementation slightly modified from FIG. 5, the input data may be digital images and the data encoder may be implemented to superpose a secrete image pattern onto the input images (see FIG. 9 and the corresponding description below). The secrete pattern may be used as a digital signature. The data decoder 510 within the deep learning model may be implemented to recognize the secret pattern. When the pattern is correctly included in the encoded input data 508, the deep learning model proceeds to process the encoded input data 506 with the secret pattern removed. Otherwise, the deep learning model may be configured to either stop processing the input data or simply output meaningless output labels.

In the implementations of FIG. 5 above, the data encoder 504 may be distributed to a user of the deep learning model 508 separately from the model itself and in a secret manner or under license protection. A user without access to the data encoder 504 may not be able to use the deep learning model 508. In particular, such a user would not be able to correctly generate encoded input data 506, and feeding the original input data 502 rather than encoded input data to the deep learning model 508 will lead to generation of output labels that are meaningless. In this scheme, the deep learning model 508 may not need to be protected (e.g., associated with license keys) and may be broadly distributed without restriction.

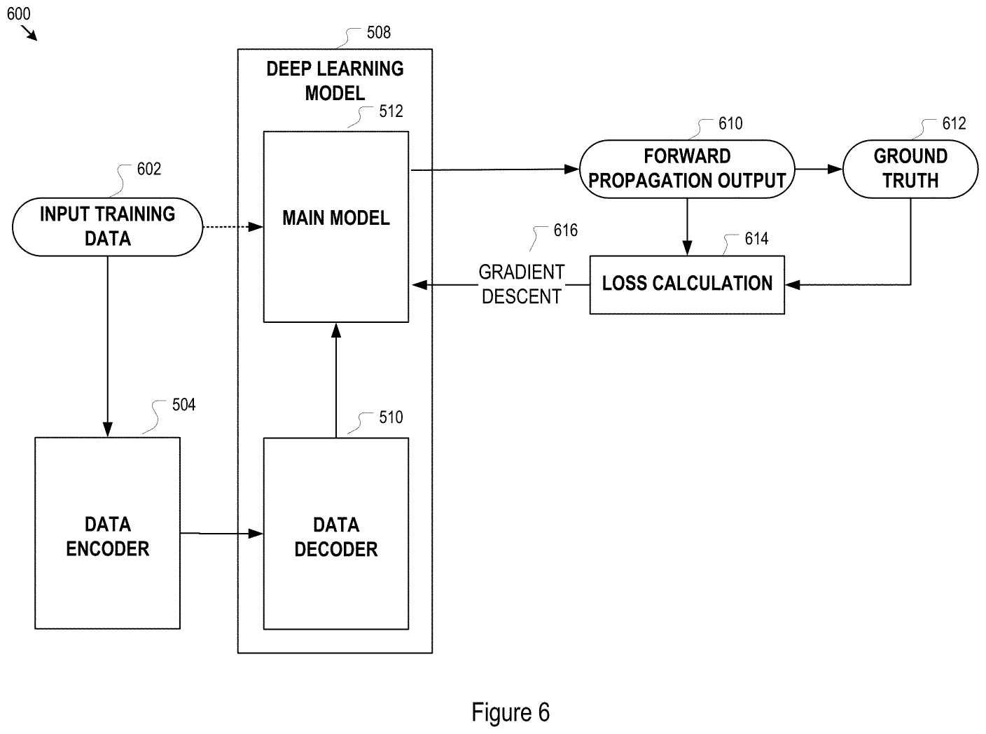

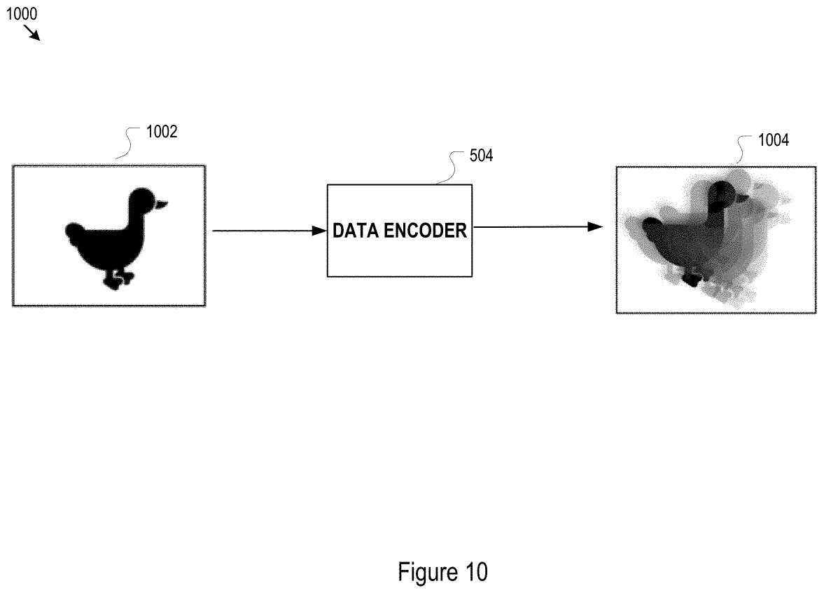

FIG. 6 illustrates an exemplary training process for the deep learning model 508 of FIG. 5. In some implementations, the input training data 602 may be directly provided to the main model for forward propagation. In some other implementations, the input training data 602 may be encoded by the data encoder 504 and then decoded by the data decoder 510 before being provided to the main model 512 for forward propagation. The latter implementations may be appropriate in situation where the data encoder 504 is designed as a lossy encoder or an encoder that is not completely reversible by a decoder such that the data decoder may not be able to completely recover the exact input training data (more details will be provided below with respect to description for FIGS. 9 and 10).

The training process involving generation of forward propagation output 610, loss calculation 614 based on the forward propagation output 610 and corresponding ground truth labels 612, and the back propagation via gradient descent 616 are similar to corresponding processes or data described in FIG. 2 and are not duplicate here for FIG. 6.

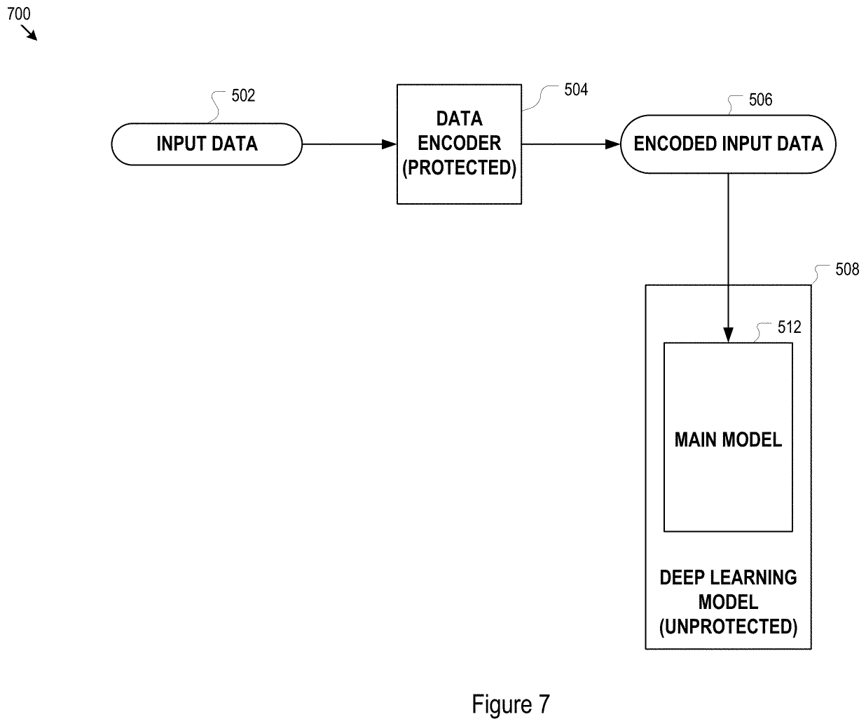

FIG. 7 illustrates another exemplary implementation for preemptive and preventive protection of the trained deep learning model 508. Like the implementation of FIG. 5, the input data in FIG. 7 is first processed by the data encoder 504 to generate encoded input data 506, and the encoded input data 506 rather than the original input data 502 is provided to the deep learning model 508 for processing. One difference between the implementation of FIG. 7 and the implementation of FIG. 5 is that the main model 512 in the implementation of FIG. 7 directly process the encoded input data without decoding it first. As such, the main model 512 is correspondingly trained to process an encoded version of the input data 506 (encoded by a data encoder 504) directly to generate output labels.

Similar to the implementation of FIG. 5, in the implementation of FIG. 7, the data encoder 504 may be separately distributed to a user of the deep learning model 508 in a secret manner or under license protection. A user without authorized access to the data encoder 504 may not be able to use the deep learning model 508. In particular, the user would not be able to generate encoded input data 506, and feeding original input data 502 rather than encoded input data to the deep learning model 508 will lead to generation of output labels that are meaningless. Again, the deep learning model 508 may not need to be protected (e.g., associated with license keys) and may be broadly distributed without restriction under this scheme.

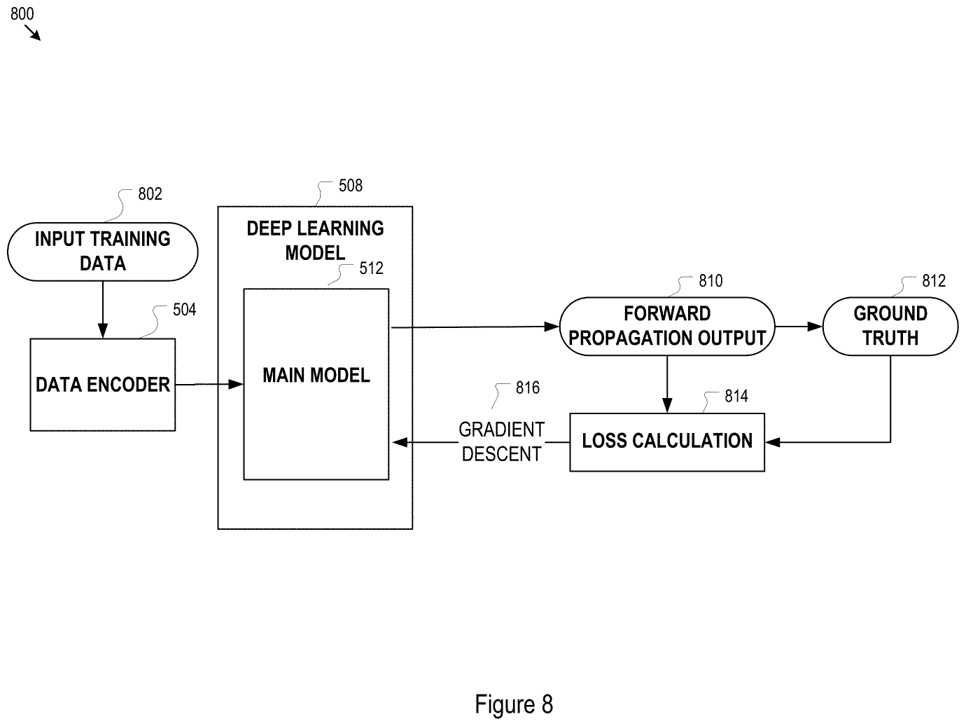

FIG. 8 illustrates an exemplary training process for the deep learning model 508 of FIG. 7. For example, the input training data 802 may be first encoded by the data encoder 504 before being provided to the main model for forward propagation. The training process involving generation of forward propagation output 810, loss calculation 814 based on the forward propagation output 810 and corresponding ground truth label 812, and the back propagation via gradient descent 816 are similar to corresponding processes or data described in FIG. 2 and are not duplicate here for FIG. 8.

In some implementations, the generation of ground truth 812 for the input training data 802 for the implementations of FIGS. 7 and 8 above may be treated in particular manners. For example, in an image segmentation application, the input training data may be digital images and the output of the deep learning model 508 may be segmentation masks. Depending on the implementation of the data encoder 504, the encoded input training data may appear drastically different from the original input training data. As such, simply using the original ground truth segmentation masks as labels for the encoded input training data in the training process for the main model 512 may yield undesirable model performance and may affect convergence and accuracy of the main model. As such, in some implementations, the ground truth may be preprocessed before being used as labels for the training process. For example, the training labels may be generated by encoding the original ground truth using the same data encoder 504 or similar data encoders.

FIG. 9 illustrates an exemplary implementation of the data encoder of FIG. 5-8. In this implementation, encoding of the input data 902 to generate encoded data 904 may be pattern based. Specifically, a unique and secret identifier pattern may be superimposed to the input data 902. Such implementation may be particular suitable in applications involving processing of digital images. In such cases, the secret pattern may include a spatial image pattern that may be superposed onto the original input images. In another example, a secrete scrambling pattern may be applied to or superposed to the input images to generate the encoded input data.

FIG. 10 illustrates an alternative implementation of the data encoder of FIG. 5-8. Specifically, the data encoder 504 may be implemented as a fixed random convolution of the input data. Again, such implementation may be particularly applicable in situation where input data are two dimensional digital images. The fixed random convolution may correspondingly be two dimensional. The kernel size for such fixed 2D random convolution may be, e.g., 3x3, or other sizes. Using a fixed random 2D convolution for encoding may minimally affect the performance of the deep learning model trained according to the implementations described above for FIGS. 6 and 8. Encoders that are more complex than the fixed random 2D convolution are also contemplated.

Implementations for the data encoder 504 illustrated in FIGS. 9 and 10 are merely examples. Other types of encoders may be used. In some implementations, the encoding schemes may be approximately reversible such that an approximate data decoder may be constructed and included as part of the deep learning model, as shown in the implementations of FIG. 5. Because of the possibility of reverse engineering, the ability to protect the model by such encoders may be compromised. In some other implementations, the data encoder 504 may be preferably constructed such that the input data and the encoded data are sufficient different and that reverse engineering of the data encoder is challenging or mathematically inaccurate, e.g., the data encoder may utilize some types of one-way functions. For these encoders, an effective decoder may not be readily available and the implementation of the deep learning model in FIG. 7 rather than FIG. 5 may be more appropriate.

Generally, the encoding scheme used by the data encoder should be relatively easy for the deep learning model to counter-react such that the ability of the main model to perform its predictive tasks is not negatively impacted in a significant manner by the inclusion of the data encoder. The data encoder 504 can be but need not be a lossless encoder. Lossless encoder may be easier to reverse engineer and thus the purpose of using the data encoder to protect the deep learning model from piracy and unauthorized uses may be subject to compromises. Lossy data encoders may be harder to reverse engineer and thus more protective of the model but may impact the training of the deep learning model and its performance after being trained. As such, the choice of the type of data encoder 504 may be made by evaluating and balancing both model performance and effectiveness of model protection.

In some implementations, the data encoder 504 in FIGS. 6 and 8 may include one or more encoder parameters. These encoder parameters may be trainable and may be trained jointly with the training of the main model 512. For example, the data encoder 504 of FIG. 8 may be trained as part of the forward propagation and back propagation paths of the deep learning model 508 during the training process. After the training, the data decoder 504 may be segregated from the deep learning model 508 and distributed to authorized users in a secret manner or under license protection.

Those having ordinary skill in the art understand that the model ownership detection implementations of FIGS. 1-4 and the preemptive and preventive protection implementations of FIGS. 5-10 may be combined. For example, the deep learning model may be trained to process encoded versions of both normal input data and special detection data. As such, only users who have access to the secret encoder may be able to generate meaningful output from the deep learning model, and even if the encoder is compromised and falls into the wrong hand, ownership of a pirated copy of the model may still be detected using the special detection data and corresponding model signatures.

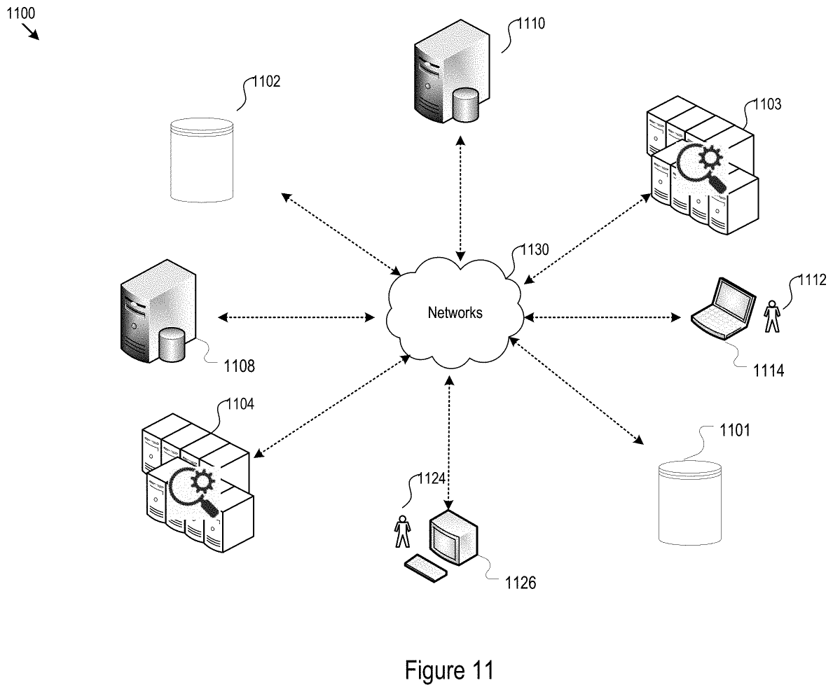

FIG. 11 shows an exemplary distributed computer platform 1100 for deploying the deep learning models of FIGS. 1, 3, 5, and 7. The computer platform 1100 may include one or more training servers 1103 and 1104, one or more databases 1101, one or more model repositories 1102, one or more model engines 1108 and 1110, model owner device 1114 associated with owner 1112, and user device 1126 associated with user 1124. These components of the computer platform 1100 are inter-connected and in communication with one another via public or private communication networks 1130.

The training servers 1103 and 1104 and model engines 1108 and 1110 may be implemented as a central server or a plurality of servers distributed in the communication networks. The training servers 1103 and 1104 may be responsible for training the deep learning models according to the various implementations discussed above. The model engines 1108 and 1110 may be responsible for processing input data using the deep learning model. The model engines 1108 and 1110 may be managed by the model owner 1112 or users 1125. While the various servers are shown in FIG. 11 as implemented as separate servers, they may be alternatively combined in a single server or single group of distributed servers combining the functionality of training and prediction. The model owner devices 1114 may be used by the model owner 1112 to access the training servers 1103 and 1104 and the model engines 1108 and 1110. The user devices 1126 may be used to access the model engines 1108 and 1110. The model owner devices 1114 and user devices 1126 may be of any form of mobile or fixed electronic devices including but not limited to desktop personal computer, laptop computers, tablets, mobile phones, personal digital assistants, and the like. The devices 1114 and 1126 may be installed with a user interface for accessing the various servers and engines.

The one or more databases 1101 of FIG. 11 may be hosted in a central database server or a plurality of distributed database servers. For example, the one or more databases 1101 may be implemented as being hosted virtually in a cloud by a cloud service provider. The one or more databases 1101 may organize data in any form, including but not limited to relational database containing data tables, graphic database containing nodes and relationships, and the like. The one or more databases 1101 may be configured to store, for example, training dataset, detection dataset and corresponding ground truth and model signatures described above.

The one or more model repositories 1102 may be used to store, for example, the deep learning model with its trained parameters. In some implementation, the model repository 1102 may be integrated as part of the model engines 1108 and 1110.

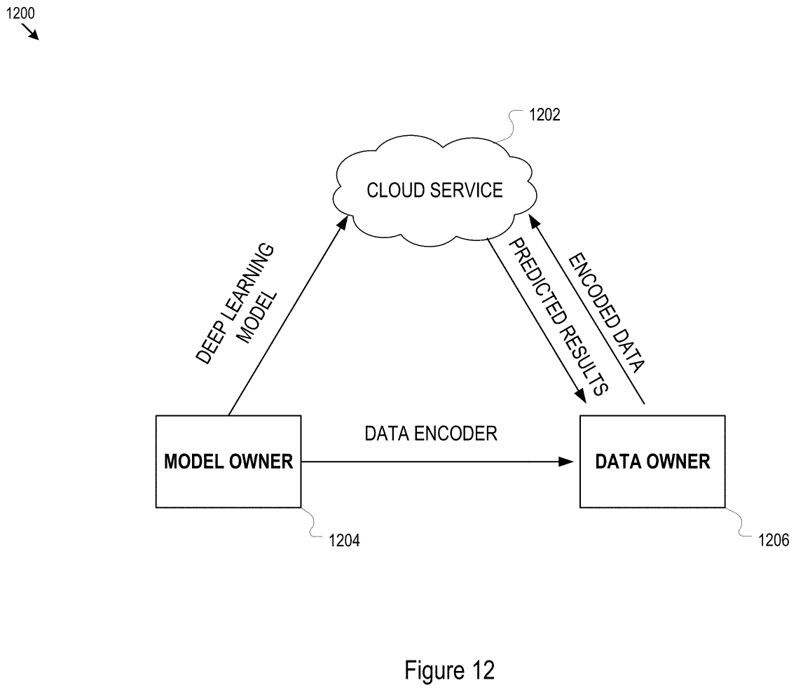

FIG. 12 shows exemplary computer platform 1200 for deployment of the deep learning models of FIGS. 5 and 7 in a cloud computing environment. For example, the model owner 1204 may distribute a deep learning model as trained via cloud service 1202. The deep learning model may be distributed without restriction and without protection. The model owner may further distribute the secret data encoder to authorized users or data owners 1206 using a different secure channel. For example, the distribution of data encoder may be license protected. The authorized users or data owners may be free to access the deep learning model deployed in the cloud service 1202. In particular, the data owner may use the protected data encoder to encode its data and upload the encoded data to the cloud, and use the deep learning model deployed in the cloud service to process its encoded data to obtain predicted results or output by the deep learning model. In such a manner, both the data of the users or data owners and the deep learning model are protected from piracy and unauthorized uses. For example, an unauthorized user may have access to the unprotected deep learning model deployed in the cloud. However, because such an unauthorized user does not have access to the secret and license protected data encoder, she would not be able to generate encoded data for the deep learning model deployed in the cloud to generate usable output labels.

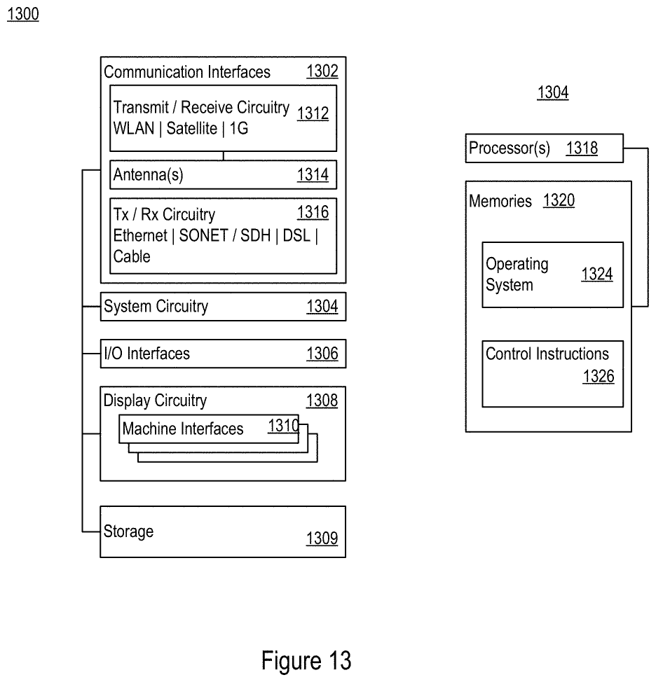

Finally, FIG. 13 shows an exemplary computer system 1300 for implementing any of the computing components in the computer platforms of FIGS. 11 and 12. The computer system 1300 may include communication interfaces 1302, system circuitry 1304, input/output (I/O) interfaces 1306, storage 1309, and display circuitry 1308 that generates machine interfaces 1310 locally or for remote display, e.g., in a web browser running on a local or remote machine. The machine interfaces 1310 and the I/O interfaces 1306 may include GUIs, touch sensitive displays, voice or facial recognition inputs, buttons, switches, speakers and other user interface elements. Additional examples of the I/O interfaces 1306 include microphones, video and still image cameras, headset and microphone input/output jacks, Universal Serial Bus (USB) connectors, memory card slots, and other types of inputs. The I/O interfaces 1306 may further include magnetic or optical media interfaces (e.g., a CDROM or DVD drive), serial and parallel bus interfaces, and keyboard and mouse interfaces.

The communication interfaces 1302 may include wireless transmitters and receivers (“transceivers”) 1312 and any antennas 1314 used by the transmitting and receiving circuitry of the transceivers 1312. The transceivers 1312 and antennas 1314 may support Wi-Fi network communications, for instance, under any version of IEEE 802.11, e.g., 802.11n or 802.11ac. The communication interfaces 1302 may also include wireline transceivers 1316. The wireline transceivers 1316 may provide physical layer interfaces for any of a wide range of communication protocols, such as any type of Ethernet, data over cable service interface specification (DOCSIS), digital subscriber line (DSL), Synchronous Optical Network (SONET), or other protocol.

The storage 1309 may be used to store various initial, intermediate, or final data needed for the implantation of the computer platforms 1100 and 1200. The storage 1309 may be separate or integrated with the one or more databases 1101 of FIG. 11. The storage 1309 may be centralized or distributed, and may be local or remote to the computer system 1300. For example, the storage 1309 may be hosted remotely by a cloud computing service provider.

The system circuitry 1304 may include hardware, software, firmware, or other circuitry in any combination. The system circuitry 1304 may be implemented, for example, with one or more systems on a chip (SoC), application specific integrated circuits (ASIC), microprocessors, discrete analog and digital circuits, and other circuitry. The system circuitry 1304 is part of the implementation of any desired functionality related to the computer platforms 1100 and 1200. As just one example, the system circuitry 1304 may include one or more instruction processors 1318 and memories 1320. The memories 1320 stores, for example, control instructions 1326 and an operating system 1324. In one implementation, the instruction processors 1318 executes the control instructions 1326 and the operating system 1324 to carry out any desired functionality related to the computer platforms 1100 and 1200.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

From the foregoing, it can be seen that this disclosure provides methods and systems for protecting a deep learning model from piracy and unauthorized uses. The protection may be implemented by embedding an ownership detection mechanism such that unauthorized use of the model may be detected using a detection input data and corresponding model signature. In addition, the deep learning model may be used in conjunction with a secret or license protected data encoder such that the deep learning model may generate meaningful output only when processing encoded input data. An unauthorized user who does not have access to the secret data encoder may not be able to use a pirated copy of the deep learning model to generate meaningful output. Under such a scheme, a deep learning model itself may be widely distributed without restriction and without license protection.

1. An artificial intelligence system, comprising:
a repository comprising a predictive deep learning model; and
a processing circuitry in communication with the repository, the processing circuitry configured to:
receive a predetermined input detection data and normal input data;
forward propagate the normal input data through the predictive deep learning model to generate a predictive output;
forward propagate the predetermined input detection data through the predictive deep learning model to generate a detection output;
obtain a difference between the detection output and a predetermined model signature corresponding to the predetermined input detection data;
determine that the predictive deep learning model is an unauthorized copy when the difference between the detection output and the predetermined model signature is smaller than a predetermined threshold; and
determine that the predictive deep learning model is not an unauthorized copy when the difference between the detection output and the predetermined model signature is not smaller than a predetermined threshold.

2. The artificial intelligence system of claim 1, wherein:
the predictive deep learning model comprises a single multilayer deep learning network; and
the single multilayer deep learning network is trained integrally using a training data set comprising input data labeled with corresponding ground truth and a predetermined set of detection data labeled with corresponding predetermined model signatures.

3. The artificial intelligence system of claim 1, wherein:
the predictive deep learning model comprises a main deep learning network and a detection network separately trained from the main deep learning network;
the predetermined input detection data is forward propagated through the detection network; and
the normal input data is forward propagated through the main deep learning network.

4. The artificial intelligence system of claim 3, wherein the main deep learning network is trained using a normal set of input training data with corresponding ground truth labels and the detection network is separately trained using a predetermined set of detection data labeled by a set of model signatures corresponding to the set of predetermined detection data.

5. The artificial intelligence system of claim 3, wherein the processing circuitry is further configured to recognize whether an input data is a normal input data or a predetermined input detection data.

6. The artificial intelligence system of claim 3, wherein the detection network and the main deep learning network comprise independent model parameters.

7. The artificial intelligence system of claim 1, wherein the predictive deep learning model comprises a multilayer convolutional neural network.

8. An artificial intelligence method, comprising:
obtaining a set of input training data each associated with one of a set of corresponding ground truth labels;
encoding each of the set of input training data using a license protected data encoder to obtain a set of encoded input training data;
training a predictive deep learning network to generate a trained predictive deep learning network by iteratively front propagating each of the set of encoded input training data through the predictive deep learning network to obtain prediction output; and back propagating loss function derived from the prediction output and ground truth labels corresponding to the set of input training data based on gradient descent, wherein a forward propagation output of an encoded input training data through the trained predictive deep learning network differs from a forward propagation output of an input training data through the trained predictive deep learning network by more than a predetermined difference threshold;
receiving an unlabeled input data;
encoding the unlabeled input data using the license protected data encoder to obtain an encoded unlabeled input data; and
forward propagating the encoded unlabeled input data through the trained predictive deep learning network to generate a predictive output label.

9. The artificial intelligence method of claim 8, wherein the predictive deep learning network is unprotected.

10. The artificial intelligence method of claim 9, wherein the predictive deep learning network is distribute via a cloud computing platform.

11. The artificial intelligence method of claim 8, wherein the license protected data encoder comprises a one-way function for converting an input data to an encoded input data.

12. The artificial intelligence method of claim 8, wherein the license protected data encoder comprises a fixed random two-dimensional convolution that converts an input data to an encoded input data.

13. The artificial intelligence method of claim 8, wherein the license protected data encoder is configured to superpose a predetermined data pattern onto an input data to generate an encoded input data.

14. The artificial intelligence method of claim 8, wherein the predictive deep learning network comprises a data decoder corresponding to the license protected data encoder in addition to and before a multilayer deep-learning network.

15. The artificial intelligence method of claim 8, where in the predictive deep learning network comprises a multilayer convolutional neural network.

16. The artificial intelligence method of claim 8, wherein the set of input training data comprises a normal input training data associated with a corresponding set of ground truth and a predetermined set of detection training data associated with a corresponding predetermined set of model signatures.

17. The artificial intelligence method of claim 16, wherein:
the predictive deep learning network comprises a single multilayer deep learning network; and
the single multilayer deep learning network is trained integrally using the normal input training data associated with the corresponding set of ground truth and the predetermined set of detection training data associated with the corresponding predetermined set of model signatures.

18. The artificial intelligence method of claim 17, further comprising:
forward propagating one of the predetermined set of detection training data through the trained predictive deep learning network to generate an detection output;
obtaining a difference between the detection output and a predetermined model signature corresponding to the one of the predetermined set of detection training data;
determining that the predictive deep learning network is an unauthorized copy when the difference between the detection output and the predetermined model signature is smaller than a predetermined threshold; and
determine that the predictive deep learning network is not an unauthorized copy when the difference between the detection output and the predetermined model signature is not smaller than a predetermined threshold

19. The artificial intelligence method of claim 16, wherein:
the predictive deep learning network comprises a main deep learning network and a detection network separately trained from the main deep learning network;
the predetermined set of detection training data and the corresponding predetermined set of model signatures is used for training the detection network; and
the normal input training data and the corresponding set of ground truth are used for training the main deep learning network.

20. The artificial intelligence method of claim 19, further comprising:
forward propagating one of the predetermined set of detection training data through the trained detection network to generate an detection output;
obtaining a difference between the detection output and a predetermined model signature corresponding to the one of the predetermined set of detection training data;
determining that the predictive deep learning network is an unauthorized copy when the difference between the detection output and the predetermined model signature is smaller than a predetermined threshold; and
determine that the predictive deep learning network is not an unauthorized copy when the difference between the detection output and the predetermined model signature is not smaller than a predetermined threshold.
